(19) United States
(12) Patent Application Publication
(10) Pub. No.: US 2018/0036973 A1
(43) Pub. Date: Feb. 8, 2018

(54) COMPOSITE REPAIR METHOD

(71) Applicant: SIKORSKY AIRCRAFT CORPORATION, Stratford, CT (US)

(72) Inventors: Nathaniel Dew, Milford, CT (US); Paul H. Denavit, Woodbridge, CT (US); Jonathan K. Garhart, Seymour, CT (US); Neil W. Cawthra, Shelton, CT (US)

(73) Assignee: Sikorsky Aircraft Corporation, Stratford, CT (US)

(21) Appl. No.: 15/550,680

(22) PCT Filed: Dec. 21, 2015
(86) PCT No.: PCT/US2015/067022

§ 371 Date: Aug. 11, 2017

Related U.S. Application Data
(60) Provisional application No. 62/119,656, filed on Feb. 23, 2015.

(51) Int. Cl. B29C 73/10

(52) U.S. Cl. CPC B29C 73/10; B29K 2105/0872

(57) ABSTRACT

A method of repairing a composite structure or forming a component of a part is provided. The method includes releasably laying up of a first member that is curable at a first temperature at or above a constrained temperature limit of the composite structure or part, releasably laying up of a second member on the first member that is curable at a second temperature below the constrained temperature limit, curing the second member into a scaffold at the second temperature at the composite structure or part, transferring the first member and the scaffold remotely from the composite structure or part for first member curing and removing the cured first member from the scaffold for bonding of the cured first member to the composite structure or part.

### FEDERAL RESEARCH STATEMENT

This invention was made with government support under W911W6-12-2-0005 awarded by the Army. The government has certain rights in the invention.

### BACKGROUND OF THE INVENTION

The subject matter disclosed herein relates to a composite repair method and, more particularly, to a method for composite repair using a room temperature cure scaffold.

In various technological applications, such as helicopter repair and maintenance, the repair of composite structures often involves bonding a laminate patch over a damaged area. In some cases, the contour of the structure to be repaired is simple enough to allow a generic precured laminate patch to be used. However, this is not always the case and more complex parts often require that the patch be laid up as a prepreg or wet layup directly on the structure to conform to the contour.

Normally, for repair of complex structures, resin systems are used that cure at reduced or room temperatures to facilitate a cure in place without compromising the base structure or surrounding systems. The material systems that enable this approach have limited mechanical properties though. This results in the repair material being insufficiently strong and in the repairs being inefficient and in some cases impractical due to the amount of material needed to meet structural requirements.

### BRIEF DESCRIPTION OF THE INVENTION

According to one aspect of the invention, a method of repairing a composite structure or forming a component of a part is provided. The method includes releasably laying up of a first member that is curable at a first temperature at or above a constrained temperature limit of the composite structure or part, releasably laying up of a second member on the first member that is curable at a second temperature below the constrained temperature limit, curing the second member into a scaffold at the second temperature at the composite structure or part, transferring the first member and the scaffold remotely from the composite structure or part for first member curing and removing the cured first member from the scaffold for bonding of the cured first member to the composite structure or part.

In accordance with additional or alternative embodiments, the composite structure or part is contoured.

In accordance with additional or alternative embodiments, the method further includes disposing release plies on either side of the first member.

In accordance with additional or alternative embodiments, the second temperature is substantially lower than both the first temperature and the constrained temperature limit.

In accordance with additional or alternative embodiments, the second temperature is room temperature.

In accordance with additional or alternative embodiments, the method further includes curing the first member at about 250° F.-350° F. or more.

In accordance with additional or alternative embodiments, the method further includes envelope vacuum bagging of the first member and the scaffold during the cure of the first member.

In accordance with additional or alternative embodiments, the method further includes bonding of the cured first member to the composite structure or part using room or elevated temperature curable adhesive and curing the adhesive at room or elevated temperature.

According to another aspect of the invention, a prepreg patch and scaffold assembly is provided and includes an autoclave or oven temperature curable prepreg patch having a contour that mimics a contour of a contoured composite structure or part and a scaffold formed of releasably laid up room temperature curable wet layup. The wet layup is releasably laid up on the prepreg patch in an uncured form to assume a contour that mimics the contour of the prepreg patch, and cured at a temperature that is lower than a curing temperature of the prepreg patch.

In accordance with additional or alternative embodiments, release plies are respectively disposed on either side of the prepreg patch.

In accordance with additional or alternative embodiments, the wet layup is curable at a temperature that is substantially lower than both a curing temperature of the prepreg patch and a constrained temperature limit.

In accordance with additional or alternative embodiments, the wet layup is heat or ultraviolet (UV) curable at room temperature.

In accordance with additional or alternative embodiments, the prepreg patch is curable at about 250° F.-350° F. or more.

In accordance with additional or alternative embodiments, an envelope vacuum bag bags the prepreg patch and the scaffold.

In accordance with additional or alternative embodiments, a room temperature curable or elevated temperature curable adhesive bonds the prepreg patch to the composite structure.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an elevational view of a contoured composite structure to be repaired;

FIG. 2 is an elevational view of a prepreg patch and a wet layup on the contoured composite structure of FIG. 1;

FIG. 3 is a schematic diagram illustrating the prepreg patch and a scaffold in an autoclave or oven for curing of the prepreg patch; and

FIG. 4 is an elevational view of the contoured composite structure of FIG. 1 and the cured prepreg patch of FIG. 3.

The detailed description explains embodiments of the invention, together with advantages and features, by way of example with reference to the drawings.

### DETAILED DESCRIPTION OF THE INVENTION

As described below, a part repair or formation approach is proposed to allow for patches or parts to be made using high temperature curing, high performance materials through a process that involves material curing in an autoclave or oven and off the structure (i.e., a contoured composite structure) being repaired or formed. Where the process is used as a repair process, the process includes fabrication of a scaffold from a wet layup that is cured in place on the structure at room or elevated temperature that is still below the service temperature of the structure or a predefined constrained temperature limit. The wet layup is laid up on a prepreg patch that is itself laid up directly on the structure with release plies disposed between the structure and the prepreg patch and between the prepreg patch and the wet layup. Once the wet layup is cured to form the scaffold, the scaffold and the prepreg patch are envelope vacuum bagged for curing in an autoclave or oven. The cured prepreg patch is then removed from the scaffold and bonded to the contoured composite structure using room temperature or elevated temperature (i.e., less than service temperature) curable adhesive.

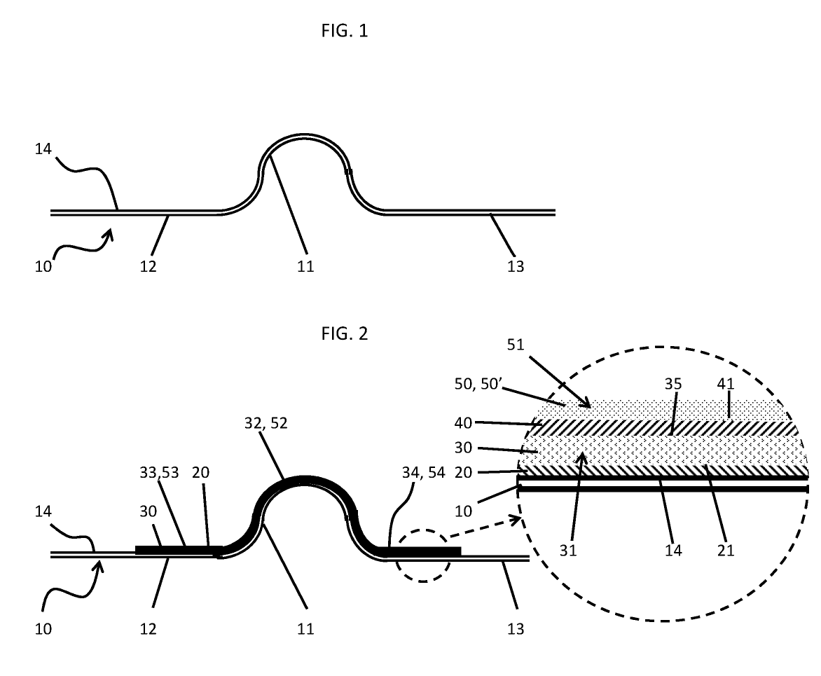

With reference to FIGS. 1-4, a method of repairing a contoured composite structure 10 or part is provided (for purposes of clarity and brevity, the following description will relate only to the case where the method is provided for repairing of the composite structure 10). The contoured composite structure 10 may include a damaged site and may be, for example, an aircraft component or a portion of an aircraft outer skin. The contoured composite structure 10 may be formed of composite structures that can be sensitive to and damaged by exposures to high temperatures such as temperatures above a predefined constrained temperature limit, temperatures above the normal service limit of the composite structure 10 and/or those temperatures used to cure high performance materials. As shown in FIG. 1, the contoured structure 10 can be flat or at least partially curved with curved portions 11 interposed between first and second flat portions 12 and 13.

Although not specifically shown in FIG. 1, the method may initially include a cleaning of the contoured structure 10. This cleaning may remove from the contoured structure 10 irregularly shaped or substantially damaged items as well as oxidized portions of the underlying materials of the contoured structure 10. In any case, the cleaning is intended to return the contoured structure 10 to or close to its nominal contour/structure.

As shown in FIGS. 1 and 2, the method includes disposing a first release ply 20 on an outer surface 14 (see FIG. 1) of the contoured structure 10 and then laying up or disposing a first member or a prepreg patch 30 on an outer surface 21 of the first release ply 20. The first release ply 20 may have a thickness of about 5 mils and is provided to permit an easy release of the prepreg patch 30 from the contoured composite structure 10. The prepreg patch 30 is formed of materials 31 that are moldable when they are not yet cured (i.e., when they are pre-cured) to mimic a shape of the contoured composite structure 10 such that, in the case of FIG. 1, the resulting prepreg patch 30 can be molded to include curved portions 32 interposed between first and second flat portions 33 and 34 where the curved portions 32 correspond to the curved portions 11 of the contoured composite structure 10 and the first and second flat portions 33 and 34 correspond to the first and second flat portions 12 and 13 of the contoured composite structure 10.

Once the prepreg patch 30 is laid up on the release ply 20 and the contoured composite structure 10, the method further includes disposing a second release ply 40 on an outer surface 35 of the prepreg patch 30 and laying up a wet laminate or layup 50 on an outer surface 41 of the second release ply. The second release ply 40 may have a thickness of about 5 mils and is provided to permit an easy release of the second release ply 40 and the second member or the wet layup 50 (to be described below) from the prepreg patch 30. The wet layup 50 is formed of materials 51 that are moldable when they are not yet cured (i.e., when they are pre-cured) to mimic a shape of the contoured composite structure 10 such that, in the case of FIG. 1, the resulting wet layup can be molded to include curved portions 52 interposed between first and second flat portions 53 and 54 where the curved portions 52 correspond to the curved portions 11 of the contoured composite structure 10 (and the curved portions 32 of the prepreg patch 30) and the first and second flat portions 53 and 54 correspond to the first and second flat portions 12 and 13 of the contoured composite structure 10 (and the first and second flat portions 33 and 34 of the prepreg patch 30).

In accordance with embodiments, the materials 31 of the prepreg patch 30 include high temperature curing materials and will be described further below. By contrast, the materials 51 of the wet layup 50 include epoxy and/or are formed of a laminate with a low or room temperature curing resin system and/or, in some cases, with an ultraviolet (UV) curing resin system. As such, the materials 51 can be heat (and/or possibly UV) cured at a relatively low or room temperature, which is at least lower than a temperature at which the materials 31 are curable and a constrained temperature limit that is predefined at least partially based on the materials of the contoured structure 10 or those temperatures at which the materials of the contoured structure 10 are or would be subject to thermal excursions. Such curing of the materials 51 transforms the wet layup 50 into a scaffold 50′, which can thus be formed on the contoured structure 10 and the prepreg patch 30 without damaging or further damaging the materials of the contoured structure 10 due to thermal excursions or water/fluid vaporization. In addition, the curing of the materials 51 and the coincident transformation of the wet layup 50 into the scaffold 50′ allows the prepreg patch 30 to be molded to the contour of and then removed from the contoured structure 10.

While the embodiments described herein generally relate to the second member of the wet layup 50, it is to be understood that other types of materials or members can be used as a low temperature curable feature that can be cured into the scaffold 50′.

In accordance with further embodiments, the constrained temperature limit of the composite structure 10 is predefined at least partially based on the materials of the contoured structure and additional factors. These additional factors include, but are not limited to, thermal limitations of the composite structure 10 (i.e., to avoid physical degradation), thermal limitations of surface treatments and coatings of the composite structure 10, such as paint or appliques, thermal limitations on proximal equipment or installs, avoiding outgassing of the composite structure 10 or the proximal equipment of installs due to a phase change of absorbed liquid, such as water/fluid, thermal expansion constraints leading to local strains, thermal conductivity sufficient to impede heating to cure temperatures and an inability to generate heat at the repair site due to lack of power (i.e. disabled aircraft at remote location).

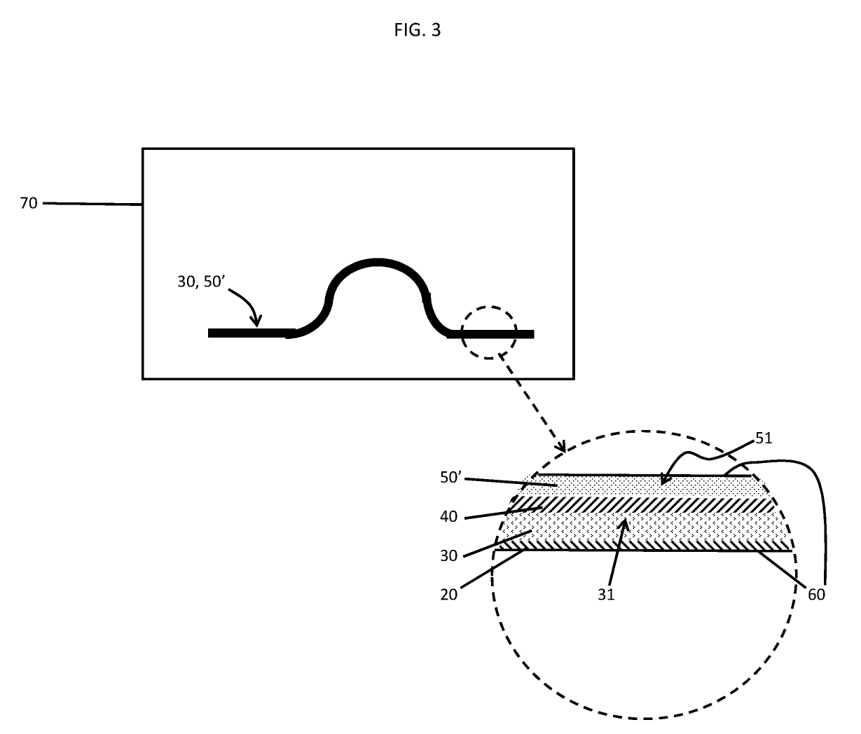

Once the materials 51 of the wet layup 50 are cured to transform wet layup into the scaffold 50′, the prepreg patch 30, the second release ply 40 and the scaffold 50′ are removed or released from the contoured structure 10. At this point, the first release ply 20 can be, but is not required to be, removed from the contoured structure 10 and, as shown in FIG. 3, the prepreg patch 30, the second release ply 40 and the scaffold 50′ are envelope vacuum bagged within an envelope bag 60 and placed in an autoclave or oven 70 such that the prepreg patch 30 can be heat cured remotely from the composite structure 10. In the meantime, since the prepreg patch 30 remains coupled with the second release ply 40 and the scaffold 50′, the prepreg patch 30 is supported by the scaffold 50′ so that its shape (i.e., its contoured structure mimicking shape) is maintained by the now room temperature cured scaffold 50′.

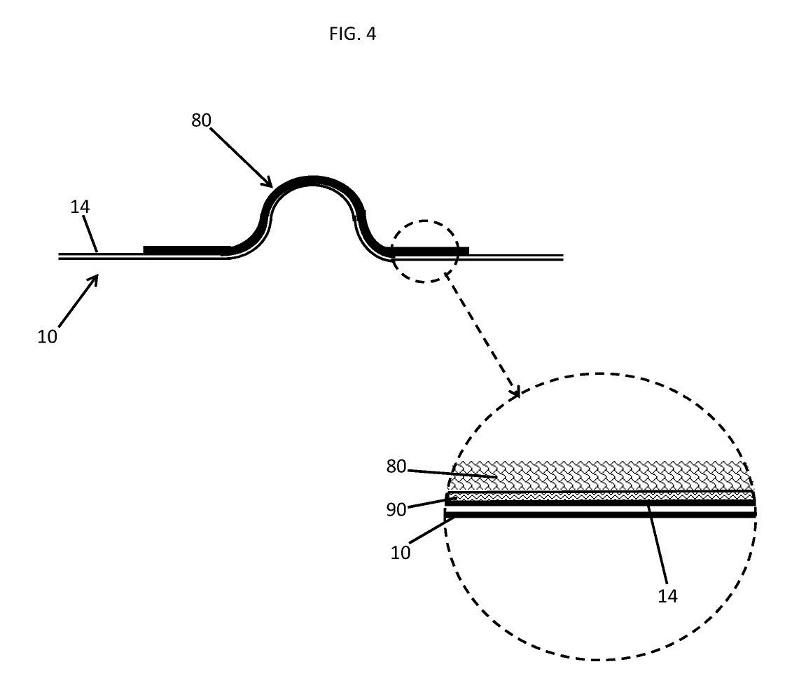

The heat curing of the prepreg patch 30 remotely from the composite structure 10 in the autoclave or oven 70 transforms the prepreg patch 30 into a repair patch 80 (see FIG. 4). The heat curing may be executed at or around about 250° F.-350° F. or more as an example. More generally, the heat curing is executed at or well above the curing temperature of the materials 51 of the wet layup 50/scaffold 50′, the predefined constrained temperature limit and the temperature at which the materials of the contoured structure 10 are or would be subject to the thermal excursions.

In accordance with embodiments, the materials 31 of the prepreg patch 30 may be curable at the relatively high temperatures noted above. In particular, the prepreg patch 30 may be formed of carbon fiber. In any case, since the prepreg patch 30 is curable at the relatively high temperatures noted above, the materials 31 can be formed of high performance materials that are capable of handling the loads experienced by the contoured structure 10. However, since the prepreg patch 30 is cured remotely from the composite structure 10 in the autoclave or oven 70 and not on the contoured structure 10, the contoured structure 10 is not exposed to the high heat required for the curing of the prepreg patch 30. Thus, the repair patch 80 can be formed as a high performance component without causing thermal excursions, water/fluid vaporization or heat damage to the contoured structure 10.

As shown in FIG. 4, once the prepreg patch 30 is cured and the repair patch 80 is formed, the repair patch 80 can be removed from the second release ply 40 and adhered to the outer surface 14 of the contoured structure 10. The adhering is achieved by interposing curing adhesive 90 between the repair patch 80 and the outer surface 14 of the contoured structure 10. The adhesive 90 is heat or UV curable at a temperature that is similar to or slightly above/elevated with respect to the curing temperature of the materials 51 of the wet layup 50. As such, the adhering does not lead to thermal excursions or heat damage to the contoured structure 10. In addition, a thickness of the adhesive 90 may be similar to the thickness of the first release ply 20 to insure a close fit of the repair patch 80 and the outer surface 14.

The described processes noted above provide for establishment of a repair patch that conforms to an exact local contour of a part to be repaired without thermal excursion of the part. In doing so, the processes facilitate execution of repairs using high performance materials that require high temperature curing. The processes are applicable to all composite structures with complex contours, which would require in situ repairs but could otherwise be compromised by local thermal excursions. This spans many industrial sectors, including current and future automotive applications among others.

In addition, since the prepreg patch 30 is ultimately removed from the second release ply 40 and the wet layup 50/scaffold 50′, an amount of the materials 51 used to form the wet layup 50/scaffold 50′ is not limited by the particular application being conducted. That is, for a given repair process for a given contoured structure 10, any amount of the materials 51 can be used to form the wet layup 50/scaffold 50′ since those materials will not be present in the actual repair patch 80 that is ultimately being formed. The added materials 51 may provide for a scaffold 50′ of increased thickness and thus greater strength and durability during the curing processes of the prepreg patch 30.

In accordance with still further embodiments, the processes described above may be used to form the repair patch 80 in order to repair the contoured structure 10 or to form a new part that can be contoured to any predefined size or shape. In such cases, the uncured forms of the prepreg patch 30 and the wet layup 50 are contoured to the predefined size or shape without the need for placement of the prepreg patch 30, the wet layup 50 or the first and second release plies 20 and 40 on an already formed part or by placement thereof on a mold.

In accordance with another aspect of the invention, a prepreg patch and scaffold assembly is provided. The assembly includes the autoclave or oven temperature curable prepreg patch 30 described above as having a contour that mimics a contour of the contoured composite structure 10 and a scaffold 50′. Again, as described above, the scaffold 50′ is formed of releasably laid up room or elevated temperature curable wet layup 50, which is releasably laid up on the prepreg patch 30 in an uncured form to assume a contour that mimics the contour of the prepreg patch 30, and is cured at a temperature that is lower than a curing temperature of the prepreg patch 30.

In accordance with further embodiments, the assembly further includes the first and second release plies 20 and 40, which are respectively disposed on either side of the prepreg patch 30. Also, the wet layup 50 is heat or UV curable at a temperature (e.g., room temperature) that is substantially lower than both a curing temperature of the prepreg patch 30, which is curable at about 250° F.-350° F. or more (e.g., about 600° F.-700° F.), the constrained temperature limit of the composite structure 10 and a temperature at which materials of the contoured composite structure 10 are subject to thermal excursions. The assembly may further include the envelope vacuum bag 60, which serves to bag the prepreg patch 30 and the scaffold 50′, as well as a room temperature or elevated temperature curable adhesive 90, which bonds the prepreg patch 30 to the contoured composite structure 10.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of repairing a composite structure or forming a component of a part, the method comprising:
releasably laying up of a first member that is curable at a first temperature at or above a constrained temperature limit of the composite structure or part;
releasably laying up of a second member on the first member that is curable at a second temperature below the constrained temperature limit;
curing the second member into a scaffold at the second temperature at the composite structure or part;
transferring the first member and the scaffold remotely from the composite structure or part for first member curing; and
removing the cured first member from the scaffold for bonding of the cured first member to the composite structure or part.

2. The method according to claim 1, wherein the composite structure or part is contoured.

3. The method according to claim 1, wherein the method further comprises disposing release plies on either side of the first member.

4. The method according to claim 1, wherein the second temperature is substantially lower than both the first temperature and the constrained temperature limit.

5. The method according to claim 1, wherein the second temperature is room temperature.

6. The method according to claim 1, further comprising curing the first member at about 250° F.-350° F. or more.

7. The method according to claim 1, further comprising envelope vacuum bagging of the first member and the scaffold.

8. The method according to claim 1, further comprising:
bonding of the cured first member to the composite structure or part using room or elevated temperature curable adhesive; and
curing the adhesive at room or elevated temperature.

9. A prepreg patch and scaffold assembly, comprising:
an autoclave or oven temperature curable prepreg patch having a contour that mimics a contour of a contoured composite structure or part; and
a scaffold formed of releasably laid up room temperature curable wet layup, the wet layup being:
releasably laid up on the prepreg patch in an uncured form to assume a contour that mimics the contour of the prepreg patch, and
cured at a temperature that is lower than a curing temperature of the prepreg patch.

10. The assembly according to claim 9, further comprising release plies respectively disposed on either side of the prepreg patch.

11. The assembly according to claim 9, wherein the wet layup is curable at a temperature that is substantially lower than both a curing temperature of the prepreg patch and a constrained temperature limit of the composite structure or part.

12. The assembly according to claim 9, wherein the wet layup is heat or ultraviolet (UV) curable at room temperature.

13. The assembly according to claim 9, wherein the prepreg patch is curable at about 250° F.-350° F. or more.

14. The assembly according to claim 9, further comprising an envelope vacuum bag to bag the prepreg patch and the scaffold.

15. The assembly according to claim 9, further comprising a room temperature or elevated temperature curable adhesive to bond the prepreg patch to the composite structure.
